(19) United States
(12) Patent Application Publication
(10) Pub. No.: US 2017/0245202 A1
(43) Pub. Date: Aug. 24, 2017

(54) WIRELESS ACCESS SETTING DEVICE

(71) Applicant: PLANET TECHNOLOGY CORPORATION, New Taipei City (TW)

(72) Inventors: Yi-Shen SHIH, New Taipei City (TW); Shih-Sheng KANG, New Taipei City (TW); Chi-Tong Leong, New Taipei City (TW)

(21) Appl. No.: 15/130,607

(22) Filed: Apr. 15, 2016

(30) Foreign Application Priority Data
Feb. 23, 2016 (TW) 105105330

(51) Int. Cl. H04W 48/10; H04H 20/16; H04L 12/46

(52) U.S. Cl. CPC H04W 48/10; H04L 12/4641; H04H 20/16; H04W 88/12

(57) ABSTRACT

A wireless access setting device is disclosed. The wireless access setting device includes a wireless access point and a wireless access controller connected thereof. The wireless access point broadcasts target identification data, and the wireless access controller presets pairing data for the target identification data corresponding to virtual local area networks (VLANs). When a wireless communication device receives the target identification data, the wireless communication device transmits its first media access control address to the wireless access point according to the target identification data to store them. The wireless access point transmits its second media access control address, the first media access control address and the target identification data corresponded thereof to the wireless access controller to store them, there by cooperating with the pairing data to control the wireless communication device and the corresponding VLAN to transmit packets through the wireless access point.

This application claims priority for Taiwan patent application no. 105105330 filed on Feb. 23, 2016, the content of which is incorporated in its entirely.

### BACKGROUND OF THE INVENTION

Field of the Invention

The present invention relates to a setting device, particularly to a wireless access setting device.

Description of the Related Art

For wireless network access, different users use different rear-end network services nowadays. For example, staffs of a company use an internal network of the company, or clients use a dedicated wireless network for clients. Based on security considerations, packets of the two networks are distributed. In the conventional technology, different service set identifiers (SSIDs) are used to connect with the networks. However, not all the wireless access points are provided with 802.3q virtual local area networks (VLANs) to distribute the network data. As a result, the users that need different services cannot use this kind of wireless access point to effectively distribute the data and to guarantee security of the data. Besides, a switch connected with the wireless access point needs to be also set. For example, the switch is manually set for VLANs, which results in burdens and confusion of a manager.

In the conventional technology, a media access control address of a user is firstly recorded. Then, a corresponding VLAN value is inputted and set in the switch. Finally, the Internet is opened to the user. If there are many users or wireless access points, the manager repeatedly performs the abovementioned setting many times, which costs a lot of time and may be faulted. For example, in order to distribute the packets from the users, before transmitting the packets, the manager manually collects media access control (MAC) addresses of the users and sets the MAC addresses to correspond to VLANs according to a group of used SSIDs, thereby binding MAC/VLAN/SSID. If the wireless access point has a VLAN tagging function, the packets are automatically distributed to the corresponding VLAN when passing the switch. For example, when 802.1q packets from the wireless access point enter into a switch processing unit, the 802.1q tagging packets are directly dumped to ports of the corresponding VLANs. Since the user does not transmit the MAC data back to the wireless access controller, there is security consideration that the MAC addresses of the users are not tracked by the manager but directly connects to the Internet. If the wireless access point does not have the VLAN tagging function, the manager has to set the MAC addresses one by one in the switches. If a turnover of staff occurs, the manager immediately has to set the MAC addresses to achieve different requirement of different users. For example, the user roams among different wireless access points or different groups. If the setting is not automatized, the manager endlessly sets the equipment. To overcome the abovementioned problems, the present invention provides a wireless access setting device, so as to solve the afore-mentioned problems of the prior art.

### SUMMARY OF THE INVENTION

A primary objective of the present invention is to provide a wireless access setting device, which presets pairing data for target identification datum corresponding to virtual local area networks (VLANs) in a wireless access controller, whereby packets are automatically dumped to the VLAN as a destination according to the setting when a user is in connection to manage and distribute the packets, thereby reducing the times of the additional setting and overcoming the problem with difficult management and security for data distribution.

To achieve the abovementioned objectives, the present invention provides a wireless access setting device connected with at least two virtual local area networks (VLANs) and controlling at least one or a plurality of wireless communication devices and the VLAN to transmit packets. The wireless access setting device comprises at least one wireless access point and a wireless access controller. The wireless access point broadcasts at least one target identification datum, such as a service set identifier (SSID). When at least one wireless communication device receives the target identification datum, the wireless communication device transmits its first media access control address and the target identification datum corresponded thereof to the wireless access point according to the target identification datum received and stores them in the wireless access point. The wireless access point outputs its second media access control address, the first media access control address and the target identification datum corresponded thereof. The wireless access controller is connected with the wireless access point and the VLANs through unshielded twisted pairs (UTPs) and presets pairing data for the target identification datum corresponding to the VLAN. The wireless access controller automatically receives the second media access control address, the first media access control address and the target identification datum corresponded thereof, stores them in pairs and uses them and the pairing data to control the wireless communication device and the corresponding VLAN to transmit the packets through the wireless access point.

The wireless access controller regularly transmits check packets to the corresponding wireless access point according to the target identification datum. The wireless access point uses the check packets to find the first media access control address which is stored by itself and which corresponds to the target identification datum, and transmits response packets corresponded thereof to the wireless access controller. When at least one first media access control address leaves the wireless access point and the wireless access controller uses the response packets to determines the first media access control address stored in the wireless access controller is not stored in the wireless access point, the wireless access controller removes the first media access control address which is stored by itself and which is not stored in the wireless access point, and its setting for the second media access control address, the target identification datum and the VLAN.

The wireless access point finds the first media access control address which is stored by itself and which corresponds to the target identification datum, and regularly transmits leave packets corresponded thereof to the wireless access controller. When at least one first media access control address leaves the wireless access point and the wireless access controller uses the leave packets to determines the first media access control address stored in the wireless access controller is not stored in the wireless access point, the wireless access controller removes the first media access control address which is stored by itself and which is not stored in the wireless access point, and its setting for the second media access control address, the target identification datum and the VLAN.

The wireless access controller further comprises a first power supply, a transmission power source unit, a first processor, a first memory and a packet switch. The first power supply receives a first external voltage, converts the first external voltage into a first direct-current (DC) voltage and outputs the first DC voltage, wherein the first external voltage is an alternative-current (AC) voltage or a DC voltage. The transmission power source unit is connected with the first power supply and the wireless access point and receives the first DC voltage. The first processor is connected with the transmission power source unit, receives the first DC voltage, and uses the first DC voltage to control the transmission power source unit to supply the first DC voltage to the wireless access point. The first memory is connected with the first processor and stores the pairing data. The packet switch is connected with the VLANs, the transmission power source unit and the first processor, receives the first DC voltage to receive the second media access control address, the first media access control address and the target identification datum corresponded thereof through the transmission power source unit, and uses the first processor to store them in the first memory in pairs. The packet switch and the first processor use the second media access control address, the first media access control address, the target identification datum corresponded thereof and the pairing data to control the wireless communication device and the corresponding the VLAN through the transmission power source unit and the wireless access point.

The wireless access point is realized with at least two embodiments. In an embodiment, the wireless access point further comprise a wireless transceiver unit, a second memory, a transmission powered unit and a second processor. The second memory stores the target identification datum. The transmission powered unit is connected with the transmission power source unit. The second processor is connected with the transmission powered unit, the wireless transceiver unit and the second memory, receives the first DC voltage through the transmission powered unit, uses the wireless transceiver unit to broadcast the target identification datum and to receive the first media access control address and the target identification datum corresponded thereof, stores the first media access control address in the second memory, and outputs its the second media access control address, the first media access control address and the target identification datum corresponded thereof through the transmission powered unit.

In another embodiment, the wireless access point further comprise a wireless transceiver unit, a second memory, a second power supply, a transmission powered unit and a second processor. The second memory stores the target identification datum. The second power supply receives a second external voltage and converts the second external voltage into a second DC voltage. The transmission powered unit is connected with the transmission power source unit and the second power supply. The second processor is connected with the transmission powered unit, the wireless transceiver unit and the second memory, receives the second DC voltage through the transmission powered unit, uses the wireless transceiver unit to broadcast the target identification datum and to receive the first media access control address and the target identification datum corresponded thereof, stores the first media access control address in the second memory, and outputs its the second media access control address, the first media access control address and the target identification datum corresponded thereof through the transmission powered unit.

Below, the embodiments are described in detail in cooperation with the drawings to make easily understood the technical contents, characteristics and accomplishments of the present invention.

### BRIEF DESCRIPTION OF THE DRAWINGS

FIG. 1 is a diagram schematically showing a wireless access setting device according to the first embodiment of the present invention;

FIG. 2 is a flowchart of connecting a wireless communication device with corresponding virtual local area network (VLAN) according to an embodiment of the present invention;

FIG. 3 is a flowchart of a wireless access controller transmitting check packets according to an embodiment of the present invention;

FIG. 4 is a flowchart of a wireless access point transmitting leave packets according to an embodiment of the present invention; and

FIG. 5 is a diagram schematically showing a wireless access setting device according to the second embodiment of the present invention.

### DETAILED DESCRIPTION OF THE INVENTION

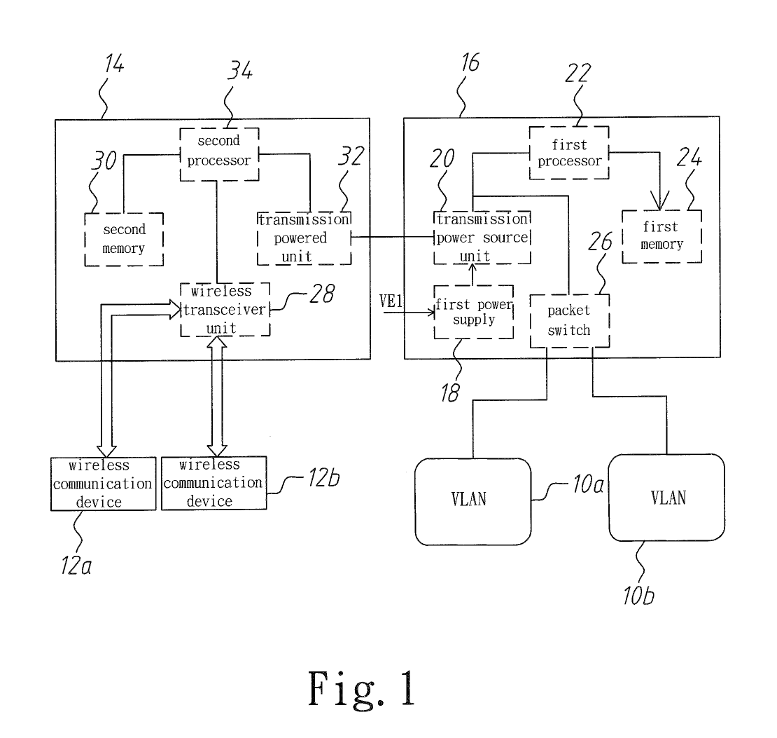

Refer to FIG. 1. The first embodiment of the wireless access setting device of the present invention is introduced. The wireless access setting device of the present invention is connected with at least two virtual local area networks (VLANs) 10a and 10b and controls at least one wireless communication device 12a or 12b and the VLANs 10a and 10b to transmit packets. For example, the amount of the VLANs 10a and 10b is two. The VLANs 10a and 10b also cooperate with a plurality of wireless communication devices to transmit packets. For example, the amount of the wireless communication devices 12a and 12b is two. The VLANs 10a and 10b are formed by routers connected with a plurality of servers. The wireless access setting device of the present invention comprises at least one wireless access point 14 and a wireless access controller 16 connected with the wireless access point 14 through an unshielded twisted pair (UTP). A manager can log in to a Web page management interface of the wireless access controller 16, so as to set and manage the system. The wireless access point 14 and the wireless access controller 16 can use a network control protocol to communicate with each other. For example, the network control protocol is a smart discovery protocol. The wireless access point 14 broadcasts at least one target identification datum, such as a service set identifier (SSID). For example, the two different target identification data is used in the embodiment. The amount of the wireless access point 14 is one. When the two wireless communication devices 12a and 12b respectively receive the target identification data, the wireless communication devices 12a and 12b transmit their first media access control addresses and the target identification data corresponded thereof to the wireless access point 14 according to the target identification data received and stores them in the wireless access point 14. Using the network control protocol, the wireless access point 14 outputs its second media access control address, the first media access control addresses and the target identification data corresponded thereof. The wireless access controller 16 is connected with the VLANs 10a and 10b and presets pairing data for the two target identification data corresponding to the VLANs 10a and 10b. Using the network control protocol, the wireless access controller 16 automatically receives the second media access control address, the first media access control addresses and the target identification data corresponded thereof, stores them in pairs and uses them and the pairing data to control the wireless communication devices 12a and 12b and the corresponding VLANs 10a and 10b to transmit the packets through the wireless access point 14.

The wireless access controller 16 further comprises a first power supply 18, a transmission power source unit 20, a first processor 22, a first memory 24 and a packet switch 26, wherein the transmission power source unit 20 complies with a communication protocol of IEEE802.3af or IEEE802.3at. The first power supply 18 receives a first external voltage VE1, converts the first external voltage VE1 into a first direct-current (DC) voltage and outputs the first DC voltage, wherein the first external voltage VE1 is an alternative-current (AC) voltage or a DC voltage. The transmission power source unit 20 is connected with the first power supply 18 and the wireless access point 14 and receives the first DC voltage. The first processor 22 is connected with the transmission power source unit 20, receives the first DC voltage, and uses the first DC voltage to control the transmission power source unit 20 to supply the first DC voltage to the wireless access point 14. The first memory 24 is connected with the first processor 22 and stores the pairing data. The packet switch 26 is connected with the VLANs 10a and 10b, the transmission power source unit 20 and the first processor 22, receives the first DC voltage, uses the first DC voltage and the network control protocol to receive the second media access control address, the first media access control addresses and the target identification data corresponded thereof through the transmission power source unit 20, and uses the first processor 22 to store them in the first memory 24 in pairs. The packet switch 26 and the first processor 22 use the second media access control address, the first media access control addresses, the target identification data corresponded thereof and the pairing data to control the wireless communication devices 12a and 12b and the corresponding the VLANs 10a and 10b to transmit the packets through the transmission power source unit 20 and the wireless access point 14.

The wireless access point 14 further comprise a wireless transceiver unit 28, a second memory 30 storing the two target identification data, a transmission powered unit 32 and a second processor 34, wherein the wireless transceiver unit 28 complies with a communication protocol of IEEE802.11a, IEEE802.11b, IEEE802.11g, IEEE802.11n or IEEE802.11ac, and wherein the transmission powered unit 32 complies with a communication protocol of IEEE802.3at or IEEE802.3af. The transmission powered unit 32 is connected with the transmission power source unit 20. The second processor 34 is connected with the transmission powered unit 32, the wireless transceiver unit 28 and the second memory 30, receives the first DC voltage through the transmission powered unit 32, uses the wireless transceiver unit 28 to broadcast the target identification data and to receive the first media access control addresses and the target identification data corresponded thereof, and stores the first media access control addresses in the second memory 30. Using the network control protocol, the second processor 34 outputs its the second media access control address, the first media access control addresses and the target identification data corresponded thereof through the transmission powered unit 32. When a user uses an appointed target identification datum to perform connection, the wireless access controller 16 immediately and automatically dumps packets to the VLAN as a destination according to the setting, so as to conveniently manage and distribute the packets, thereby achieving central automation setting, reducing the times of the additional setting and overcoming the problem with difficult management and security for data distribution.

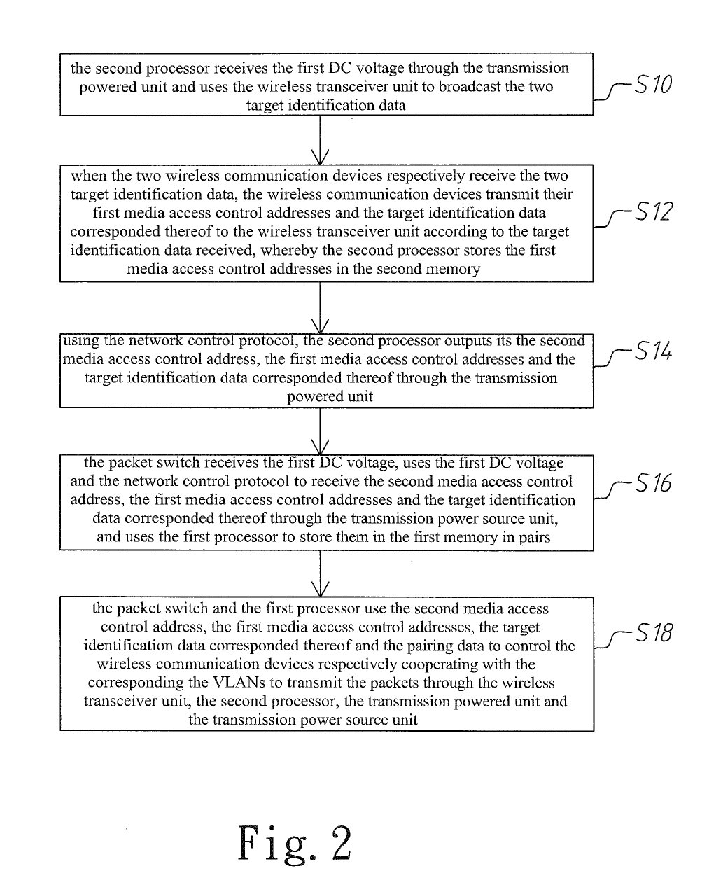

Refer to FIG. 1 and FIG. 2. The operation process of the present invention is introduced below. The process suits to the state that a new user joins, and that a user roams from a target identification datum to another target identification datum, and that a user roams from a wireless access point to another wireless access point. Firstly, in Step S10, the second processor 34 receives the first DC voltage through the transmission powered unit 32 and uses the wireless transceiver unit 28 to broadcast the two target identification data. Then, in Step S12, when the two wireless communication devices 12a and 12b respectively receive the two target identification data, the wireless communication devices 12a and 12b transmit their first media access control addresses and the target identification data corresponded thereof to the wireless transceiver unit 28 according to the target identification data received, whereby the second processor 34 stores the first media access control addresses in the second memory 30. Then, in Step S14, using the network control protocol, the second processor 34 outputs its the second media access control address, the first media access control addresses and the target identification data corresponded thereof through the transmission powered unit 32. Then, in Step S16, the packet switch 26 receives the first DC voltage, uses the first DC voltage and the network control protocol to receive the second media access control address, the first media access control addresses and the target identification data corresponded thereof through the transmission power source unit 20, and uses the first processor 22 to store them in the first memory 24 in pairs. Finally, in Step S18, the packet switch 26 and the first processor 22 use the second media access control address, the first media access control addresses, the target identification data corresponded thereof and the pairing data to control the wireless communication devices 12a and 12b respectively cooperating with the corresponding the VLANs 10a and 10b to transmit the packets through the wireless transceiver unit 28, the second processor 34, the transmission powered unit 32 and the transmission power source unit 20. As a result, the packets from staffs in a company or clients can be dumped to the corresponding network, such as an internal network of the company or a wireless network for clients.

The present invention has two kinds of ways of cleaning the first media access address. The first way is introduced below. The wireless access controller 16 regularly transmits check packets to the corresponding wireless access point 14 according to the two target identification data and the network control protocol. The wireless access point 14 uses the check packets to find the first media access control addresses which are stored by itself and which correspond to the two target identification data, and transmits response packets corresponded thereof to the wireless access controller 16 by using the network control protocol. When at least one first media access control address leaves the wireless access point 14 and the wireless access controller 16 uses the response packets to determines the first media access control address stored in the wireless access controller 16 is not stored in the wireless access point 14, the wireless access controller 16 removes the first media access control address which is stored by itself and which is not stored in the wireless access point 14, and its setting for the second media access control address, the target identification datum and the VLAN.

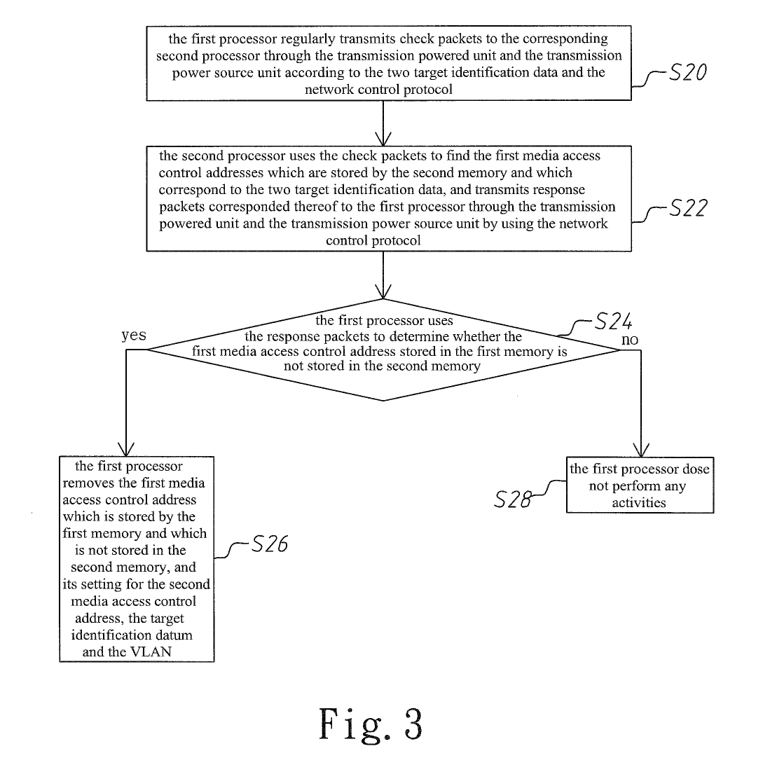

Specifically, refer to FIG. 1 and FIG. 3. Firstly, in Step S20, the first processor 22 regularly transmits check packets to the corresponding second processor 34 through the transmission powered unit 32 and the transmission power source unit 20 according to the two target identification data and the network control protocol. Then, in Step S22, the second processor 34 uses the check packets to find the first media access control addresses which are stored by the second memory 30 and which correspond to the two target identification data, and transmits response packets corresponded thereof to the first processor 22 through the transmission powered unit 32 and the transmission power source unit 20 by using the network control protocol. Then, in Step S24, the first processor 22 uses the response packets to determine whether the first media access control address stored in the first memory 24 is not stored in the second memory 30. If the answer is yes, the first processor 22 removes the first media access control address which is stored by the first memory 24 and which is not stored in the second memory 30, and its setting for the second media access control address, the target identification datum and the VLAN, as shown in Step S26. If the answer is no, the first processor 22 dose not perform any activities, as shown in Step S28. For example, when the first media access control address of the wireless communication device 12a leaves the second memory 30, the first processor 22 uses the response packets to determine whether the first media access control address of the wireless communication device 12a stored in the first memory 24 is not stored in the second memory 30. As a result, the first processor 22 removes the first media access control address of the wireless communication device 12a which is stored by the first memory 24 and which is not stored in the second memory 30, and its setting for the second media access control address, the target identification datum and the VLAN 10a.

In addition to the abovementioned way, the second way of cleaning the first media access control address is introduced below. Refer to FIG. 1. The wireless access point 14 actively finds the first media access control addresses which are stored by itself and which correspond to the two target identification data, and regularly transmits leave packets corresponded thereof to the wireless access controller 16 by using the network control protocol. When at least one first media access control address leaves the wireless access point 14 and the wireless access controller 16 uses the leave packets to determines the first media access control address stored in the wireless access controller 16 is not stored in the wireless access point 14, the wireless access controller 16 removes the first media access control address which is stored by itself and which is not stored in the wireless access point 14, and its setting for the second media access control address, the target identification datum and the VLAN.

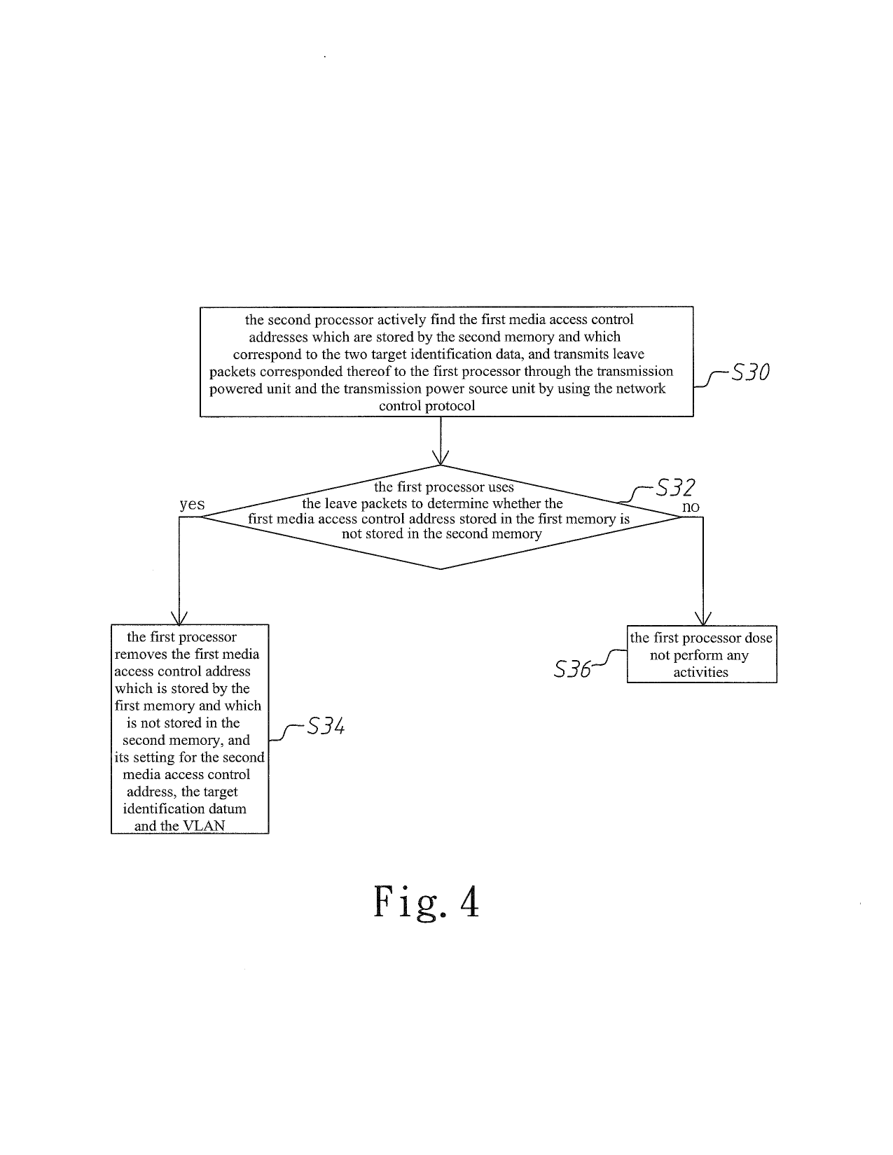

Specifically, refer to FIG. 1 and FIG. 4. Firstly, in Step S30, the second processor 34 actively find the first media access control addresses which are stored by the second memory 30 and which correspond to the two target identification data, and transmits leave packets corresponded thereof to the first processor 22 through the transmission powered unit 32 and the transmission power source unit 20 by using the network control protocol. Then, in Step S32, the first processor 22 uses the leave packets to determine whether the first media access control address stored in the first memory 24 is not stored in the second memory 30. If the answer is yes, the first processor 22 removes the first media access control address which is stored by the first memory 24 and which is not stored in the second memory 30, and its setting for the second media access control address, the target identification datum and the VLAN, as shown in Step S34. If the answer is no, the first processor 22 dose not perform any activities, as shown in Step S36. For example, when the first media access control address of the wireless communication device 12b leaves the second memory 30, the first processor 22 uses the leave packets to determine whether the first media access control address of the wireless communication device 12b stored in the first memory 24 is not stored in the second memory 30. As a result, the first processor 22 removes the first media access control address of the wireless communication device 12b which is stored by the first memory 24 and which is not stored in the second memory 30, and its setting for the second media access control address, the target identification datum and the VLAN 10b.

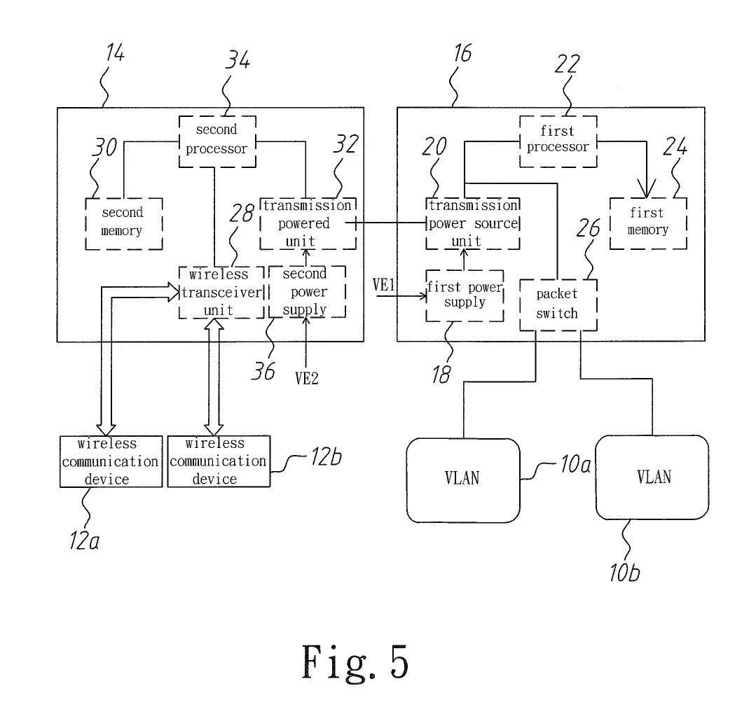

Refer to FIG. 5. The second embodiment of the wireless access setting device of the present invention is introduced below. The second embodiment is different from in that the first embodiment in an internal circuit of the wireless access point 14 and that the transmission powered unit 32 and the transmission power source unit 20 do not comply with a communication protocol of IEEE 802.3af or IEEE802.3at. In the second embodiment, The wireless access point 14 further comprise a wireless transceiver unit 28, a second memory 30 storing the two target identification data, a transmission powered unit 32, a second power supply 36 and a second processor 34, wherein the wireless transceiver unit 28 complies with a communication protocol of IEEE802.11a, IEEE802.11b, IEEE802.11g, IEEE802.11n or IEEE802.11ac. The transmission powered unit 32 is connected with the transmission power source unit 20 and the second power supply 36. The second power supply 36 receives a second external voltage VE2, converts the second external voltage VE2 into a second DC voltage and outputs the second DC voltage. The second processor 34 is connected with the transmission powered unit 32, the wireless transceiver unit 28 and the second memory 30, receives the second DC voltage through the transmission powered unit 32, uses the wireless transceiver unit 28 to broadcast the two target identification data and to receive the first media access control addresses and the target identification data corresponded thereof, and stores the first media access control addresses in the second memory 30. Using the network control protocol, the second processor 34 outputs its the second media access control address, the first media access control addresses and the target identification data corresponded thereof through the transmission powered unit 32.

The operation process of the second embodiment of the present invention is similar to that of FIG. 2 of the first embodiment. In Step S10 of FIG. 2, the second processor 34 receives the second DC voltage through the transmission powered unit 32 and uses the wireless transceiver unit 28 to broadcast the two target identification data, and other steps of the second embodiment are identical to those of the first embodiment so will not be reiterated. Besides, in the second embodiment, the processes of using the wireless access controller to transmit check packets and using the wireless access point to transmit leave packets are identical to those of the first embodiment, so the processes will not be reiterated.

In conclusion, the present invention presets pairing data for target identification datum corresponding to virtual local area networks (VLANs) in a wireless access controller, whereby packets are automatically dumped to the VLAN as a destination according to the setting when a user is in connection, and uses central setting automation to manage the packets to overcome the problem with security for data distribution.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A wireless access setting device connected with at least two virtual local area networks (VLANs) and controlling at least one wireless communication device and said VLAN to transmit packets, said wireless access setting device comprising:
at least one wireless access point broadcasting at least one target identification datum, and when at least one said wireless communication device receives said target identification datum, said wireless communication device transmits its first media access control address and said target identification datum corresponded thereof to said wireless access point according to said target identification datum received and stores them in said wireless access point, and said wireless access point outputs its second media access control address, said first media access control address and said target identification datum corresponded thereof; and
a wireless access controller connected with said wireless access point and said VLANs, presetting pairing data for said target identification datum corresponding to said VLAN, and said wireless access controller automatically receives said second media access control address, said first media access control address and said target identification datum corresponded thereof, stores them in pairs and uses them and said pairing data to control said wireless communication device and corresponding said VLAN to transmit said packets through said wireless access point.

2. The wireless access setting device of claim 1, wherein said target identification datum is a service set identifier (SSID).

3. The wireless access setting device of claim 1, wherein said wireless access point is connected with said wireless access controller through an unshielded twisted pair (UTP).

4. The wireless access setting device of claim 1, wherein said wireless access controller transmits check packets to corresponding said wireless access point according to said target identification datum, and said wireless access point uses said check packets to find said first media access control address which is stored by itself and which corresponds to said target identification datum, and transmits response packets corresponded thereof to said wireless access controller, and when at least one said first media access control address leaves said wireless access point and said wireless access controller uses said response packets to determines said first media access control address stored in said wireless access controller is not stored in said wireless access point, said wireless access controller removes said first media access control address which is stored by itself and which is not stored in said wireless access point, and its setting for said second media access control address, said target identification datum and said VLAN.

5. The wireless access setting device of claim 4, wherein said wireless access controller regularly transmits said check packets to said corresponding said wireless access point according to said target identification datum.

6. The wireless access setting device of claim 1, wherein said wireless access point finds said first media access control address which is stored by itself and which corresponds to said target identification datum, and transmits leave packets corresponded thereof to said wireless access controller, and when at least one said first media access control address leaves said wireless access point and said wireless access controller uses said leave packets to determines said first media access control address stored in said wireless access controller is not stored in said wireless access point, said wireless access controller removes said first media access control address which is stored by itself and which is not stored in said wireless access point, and its setting for said second media access control address, said target identification datum and said VLAN.

7. The wireless access setting device of claim 6, wherein said wireless access point finds said first media access control address which is stored by itself and which corresponds to said target identification datum, and regularly transmits said leave packets corresponded thereof to said wireless access controller.

8. The wireless access setting device of claim 1, wherein said wireless access controller further comprises:
a first power supply receiving a first external voltage, converting said first external voltage into a first direct-current (DC) voltage and outputting said first DC voltage;
a transmission power source unit connected with said first power supply and said wireless access point and receiving said first DC voltage;
a first processor connected with said transmission power source unit, receiving said first DC voltage, and using said first DC voltage to control said transmission power source unit to supply said first DC voltage to said wireless access point;
a first memory connected with said first processor and storing said pairing data; and
a packet switch connected with said VLANs, said transmission power source unit and said first processor, receiving said first DC voltage to receive said second media access control address, said first media access control address and said target identification datum corresponded thereof through said transmission power source unit, and using said first processor to store them in said first memory in pairs, and said packet switch and said first processor use said second media access control address, said first media access control address, said target identification datum corresponded thereof and said pairing data to control said wireless communication device and said corresponding said VLAN through said transmission power source unit and said wireless access point.

9. The wireless access setting device of claim 8, wherein said first external voltage is an alternative-current (AC) voltage or a DC voltage.

10. The wireless access setting device of claim 8, wherein said wireless access point further comprises:
a wireless transceiver unit;
a second memory storing said target identification datum;
a transmission powered unit connected with said transmission power source unit; and
a second processor connected with said transmission powered unit, said wireless transceiver unit and said second memory, receiving said first DC voltage through said transmission powered unit, using said wireless transceiver unit to broadcast said target identification datum and to receive said first media access control address and said target identification datum corresponded thereof, storing said first media access control address in said second memory, and outputting its said second media access control address, said first media access control address and said target identification datum corresponded thereof through said transmission powered unit.

11. The wireless access setting device of claim 8, wherein said wireless access point further comprises:
a wireless transceiver unit;
a second memory storing said target identification datum;
a second power supply receiving a second external voltage and converting said second external voltage into a second DC voltage;
a transmission powered unit connected with said transmission power source unit and said second power supply; and
a second processor connected with said transmission powered unit, said wireless transceiver unit and said second memory, receiving said second DC voltage through said transmission powered unit, using said wireless transceiver unit to broadcast said target identification datum and to receive said first media access control address and said target identification datum corresponded thereof, storing said first media access control address in said second memory, and outputting its said second media access control address, said first media access control address and said target identification datum corresponded thereof through said transmission powered unit.

12. The wireless access setting device of claim 1, wherein said wireless communication device is a plurality of said wireless communication devices.
